(19) United States
(12) Patent Application Publication
(10) Pub. No.: US 2006/0112990 A1
(43) Pub. Date: Jun. 1, 2006

(54) Liquid dispensing device and method

(76) Inventor: Amnon Shiloni, Shoham (IL)

Correspondence Address: ROBERT L STONE PC, 13 MEADOWLARK LN, EAST BRUNSWICK, NJ, 08816, US

(21) Appl. No.: 10/998,248

(22) Filed: Nov. 26, 2004

(51) Int. Cl. F16K 17/40

(52) U.S. Cl. 137/71

(57) ABSTRACT

A liquid dispensing device for use with a container for holding a liquid under pressure, the dispensing device including a cap portion for sealingly connecting the dispensing device to the container, a conduit for permitting outflow of liquid under pressure from the container, and a holder for a pressure valve providing for increasing the air pressure in the container, wherein the cap portion, conduit and holder are assembled to form a single unit before use, and a method for forming such a liquid dispensing device.

### FIELD OF THE INVENTION

The present invention relates to liquid dispensing devices in general, which can be used for hands-free drinking, especially by cyclists.

### BACKGROUND OF THE INVENTION

There are many activities in which it is desirable to be able to drink at will, but the user's hands are otherwise occupied, such as bicycling or other sporting activities. During such activities, if the user removes a conventional bottle from a holder to drink, he may lose his concentration, interrupt his view ahead, or lose his balance or his pace while using one hand for holding and returning the bottle. Similarly, among the handicapped population, there are many individuals with limited hand dexterity for whom use of a conventional bottle is difficult or impossible. Therefore, a variety of hands-free drinking vessels have been developed. Many of these include valves permitting the user to suck liquid from a vessel to the mouth.

One pressurized fluid dispensing device, particularly for cyclists, is shown in U.S. Pat. No. 5,607,087 to Wery, et al. This patent discloses a fluid dispensing device including a vessel having a sealable opening, a female coupling member operable to seal the opening and having a first check valve operable to releasably maintain a pressurized condition within the vessel, a male coupling member operable to sealingly engage the female coupling member while opening the first check valve for dispensing fluid from within the vessel, and a second check valve disposed in communication with the vessel operable for limiting pressure within the vessel. The device further includes a tubing member attached to the male coupling member which has an actuatable valve for dispensing fluid from the vessel through the tubing member. It also includes a pressure adapter operable to sealingly engage the female coupling member to communicate a pressurized condition into the vessel.

However, this dispensing device suffers from several disadvantages. First, it requires the use of a dedicated vessel which is specifically designed to receive the various coupling members of the invention. Second, the device is composed of several separate elements, each having a different function, so it is relatively complex to manufacture and maintain. In addition, if one of the coupling members is lost, the rest of the device cannot be used without a replacement. Third, in order to use this device, first the female coupling member must be coupled to the bottle. Then the pressure adapter is coupled to the female coupling member to pressurize fluid inside the bottle. Next, the pressure adapter must be removed from the female coupling member and a male coupling member is coupled to the female coupling member. Finally, tubing is mounted on the male coupling member for drinking by the user. Thus, use of this device requires several steps to assemble prior to use and during recharging of the bottle, and is cumbersome and complex for the user.

Accordingly, there is a long felt need for a simple, relatively inexpensive pressurized liquid dispensing device, and it would be very desirable to have a dispensing device which could convert any conventional soft drink or water bottle to a hands-free, pressurized water container and dispenser.

### SUMMARY OF THE INVENTION

The present invention relates to a pressurized liquid dispensing device which can be coupled to a conventional soft drink bottle or conventional aluminum water bottle, and which is relatively easy to manufacture, use and maintain.

There is provided according to the present invention a liquid dispensing device for use with a liquid container, the dispensing device including a cap portion for sealingly connecting the dispensing device to the liquid container, a conduit for permitting outflow of liquid under pressure from the liquid container, and a holder for a pressure valve for increasing the air pressure in the liquid container, wherein each of the cap portion, conduit and holder are assembled into a single unit before use.

According to a preferred embodiment of the invention, the liquid dispensing device has a unitary body wherein said cap portion, conduit and holder are integrally formed.

Further according to a preferred embodiment of the invention, the liquid container is a conventional plastic soft drink bottle, or a conventional aluminum water bottle, having a threaded neck, or any other liquid container which can hold liquid under pressure.

Further according to a preferred embodiment, the dispensing device also includes tubing sealingly coupled to the conduit having a dispensing valve mounted in the tubing for actuation by the mouth of a user, so as to permit the flow of liquid under pressure from the container to the user's mouth.

According to a preferred embodiment, a pressure valve is mounted in the integrally formed holder. The pressure valve may be a standard tire valve.

Further according to the present invention, the dispensing device also includes a relief valve for limiting the pressure inside the liquid container. Preferably, the relief valve includes a housing integrally formed with the dispensing device body.

It is a particular feature of the invention that it is suitable for hands free use. Coupling tubing having a dispensing valve to the integral conduit and arranging the other end of the tubing adjacent the mouth of the user permits a user to open the tubing, thereby causing liquid under pressure to flow from the container and out through the tubing.

There is also provided, in accordance with the invention, a method for forming a liquid dispensing device, the method including forming a unitary dispensing device body, integrally forming with the body a cap portion for sealingly connecting the dispensing device to a liquid container, integrally forming with the body a conduit for permitting outflow of liquid under pressure from the liquid container, and integrally forming with the body a holder for a pressure valve for increasing the air pressure in the liquid container.

According to one embodiment of the invention, the method further includes mounting a pressure valve in the integrally formed holder. The pressure valve may be a tire valve.

According to a preferred embodiment, the method further includes sealingly coupling tubing to the conduit, the tubing having a dispensing valve mounted therein for actuation by the mouth of a user, so as to permit the flow of liquid under pressure from the container to the user's mouth.

Further according to a preferred embodiment, the method further includes mounting a relief valve in the body. Most preferably, the method includes integrally forming with the body a housing for the relief valve.

### BRIEF DESCRIPTION OF THE DRAWINGS

The present invention will be further understood and appreciated from the following detailed description taken in conjunction with the drawings in which:

FIG. 1a is a plan view of a dispensing device constructed and operative in accordance with one embodiment of the present invention;

FIG. 1b is a schematic sectional illustration of the dispensing device of FIG. 1a;

FIG. 2 is a schematic illustration of a dispensing device according to one embodiment of the invention mounted on a bicycle for use;

FIG. 3 is a schematic sectional illustration of a dispensing device, according to another embodiment of the invention;

FIG. 4a is a perspective view of an adapter for use with the dispensing device of the invention;

FIG. 4b is a schematic sectional illustration of the adapter of FIG. 4a; and

FIG. 5 is a schematic sectional illustration of a dispensing device according to another embodiment of the invention.

### DETAILED DESCRIPTION OF THE INVENTION

The present invention relates to a dispensing device for liquid under pressure, particularly water, which can easily be assembled or manufactured as a single unit and can be utilized in conjunction with substantially any soft drink bottle or other liquid container having a neck, especially for hands free use. The dispensing device has an integrally formed cap portion for sealingly coupling to the liquid container, an integrally formed conduit for permitting outflow of liquid under pressure from the liquid container, and an integrally formed holder for a pressure valve for increasing the air pressure in the liquid container. According to a preferred embodiment of the invention, the dispensing device also includes an integral relief valve.

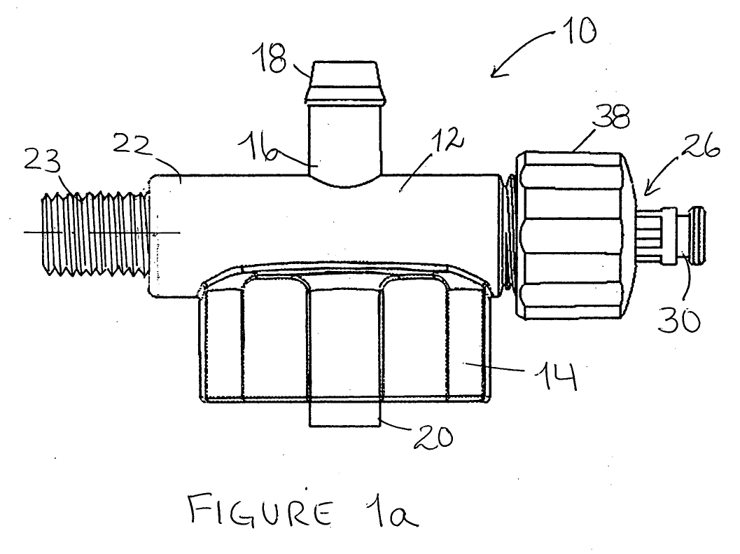

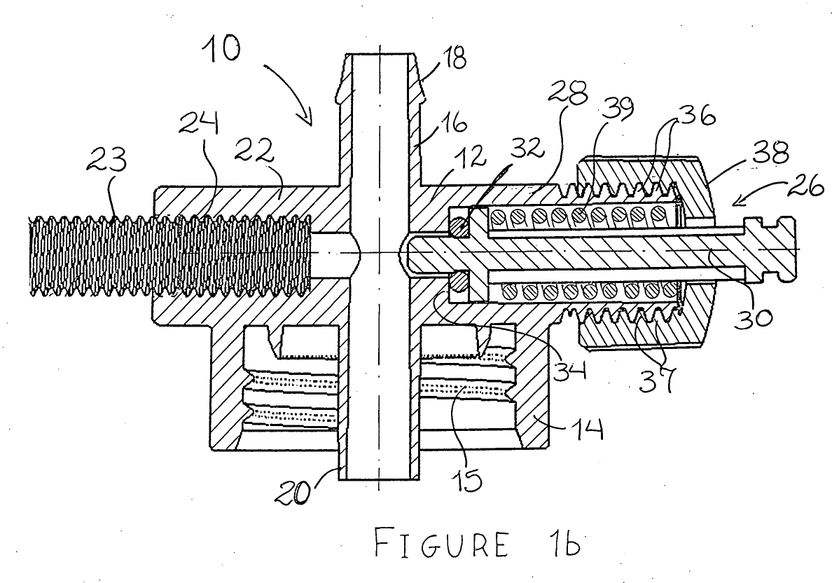

Referring now to FIGS. 1a and 1b, there are shown perspective and schematic sectional illustrations, respectively, of a dispensing device 10 constructed and operative in accordance with a preferred embodiment of the present invention. Dispensing device 10 is formed of a unitary body 12, for example, of injected plastic. Body 12 has an integrally formed cap portion 14 for sealingly connecting the dispensing device to a liquid container. In this embodiment, cap portion 14 is formed with internal screw threads 15 adapted and configured to engage the screw threads on the neck of a conventional soft drink bottle.

Body 12 also includes an integrally formed conduit 16 for permitting outflow of liquid from the liquid container. One end of conduit 16 includes an external nipple 18 adapted and configured to sealingly hold tubing (not shown) with a pressure resistant actuatable valve, and arranged to extend towards the mouth of a user. It will be appreciated that this tubing also will be under pressure during use of the dispensing device, so the coupling of the tubing to conduit 16 must be sufficiently strong to prevent inadvertent release of the tubing from conduit 16. Additional tubing may be coupled to the other end 20 of the conduit inside the container, which tubing can extend substantially to the bottom of the container.

Body 12 further includes an integrally formed holder 22 for a pressure valve 23 for introducing air under pressure into the liquid container up to a desired pressure, for example, between 3 and 5 Bar. Preferably, pressure valve 23 is built-in in holder 22. According to the embodiment of FIG. 1b, holder 22 is formed with internal screw threads 24 or other means for holding the pressure valve. The pressure valve may be any suitable element for increasing the air pressure in the container, for example, a standard tire valve tube having external mating screw threads for engaging the screw threads of the holder 22.

According to the preferred embodiment of the invention illustrated in FIGS. 1a and 1b, body 12 also includes a relief valve 26 for limiting the pressure inside the container while charging air into the container. It will be appreciated that relief valve 26 is optional, although it preferably is built-in, when it is present. The relief valve 26 illustrated in FIG. 1b includes a valve stem 30 spring-biased in a valve housing 28 integrally formed with body 12. An O-ring 32 or other sealing means is provided between valve stem 30 and valve seat 34 to prevent leakage of liquid or air. Valve housing 28 may be provided with external screw threads 36 for engaging internal screw threads 37 of a cap 38, which serves to hold spring 39 and serves as a guide and stop member for valve stem 30.

It will be appreciated that the embodiment of FIGS. 1a and 1b includes a unitary body. According to an alternative embodiment of the invention, the dispensing device may be manufactured of separate elements which are sealingly coupled to one another into a single dispensing unit before use, and preferably before marketing to the end user.

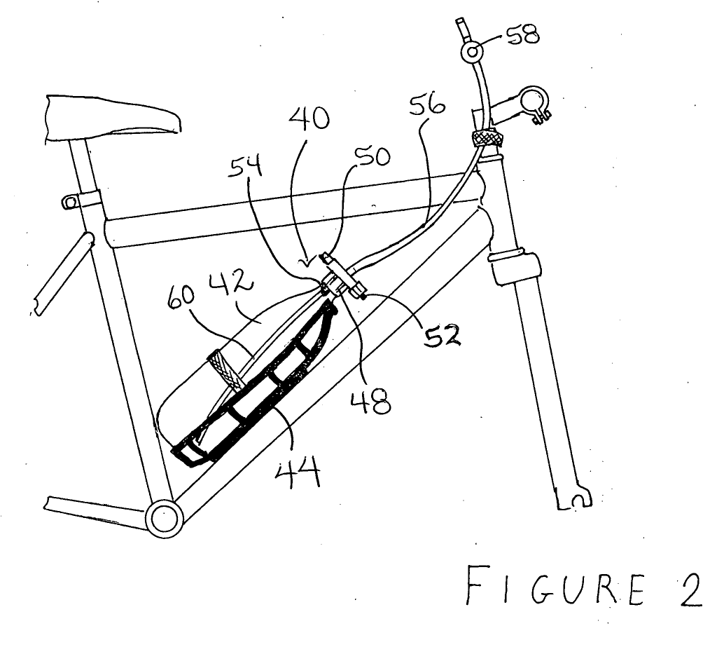

FIG. 2 is a schematic illustration of a dispensing device 40 according to the present invention coupled to a liquid container 42 for holding liquid under pressure, such as water. In this illustration, the dispensing device and liquid container are mounted on a bicycle to provide pressurized drinking water to a rider, for which the invention is particularly suited. It will be appreciated that this illustration is by way of example only, and the dispensing device of the present invention and liquid container can alternatively be mounted on a wheelchair, vehicle, sport accessory or carried on the body of the user. In the illustrated example, the liquid container 42 is mounted in a holder 44 mounted on the body of the bicycle.

Dispensing device 40 is formed of a body which may be a unitary body or a single unit assembled before use. Device 40 has an integrally formed cap portion 48 for sealingly connecting the dispensing device to the liquid container 42. It is a particular feature of the present invention that liquid container 42 may be substantially any conventional liquid container which is capable of holding liquid under pressure and having a sealable neck. Thus, the liquid container may be a conventional 1.5 or 2 liter soft drink bottle, it may be an aluminum drinking bottle, such as those manufactured and sold by SIGG Switzerland AG, of Frauenfeld, Switzerland, or any other liquid container having a suitable neck for sealable coupling to the dispensing device. In this case, cap portion 48 may be formed with internal or external screw threads adapted and configured to engage screw threads on the neck of the bottle.

Dispensing device 40 further includes a pressure valve 50 for introducing air under pressure into the liquid container 42. Pressure valve 50 is mounted in an integral holder in dispensing device 40. In this embodiment of the invention, dispensing device 40 also includes a pressure relief valve 52, sealingly mounted in device 40, for controlling the maximum pressure inside container 42 during charging air into the container.

Dispensing device 40 also includes an integrally formed conduit 54 for permitting outflow of liquid from the liquid container. The end of conduit 54 which extends outside the liquid container is adapted and configured to sealingly hold a length of tubing 56, which is arranged to extend towards the mouth of a user. Tubing 56 includes a dispensing valve 58, or other actuatable valve, preferably adjacent the mouth of the user. Dispensing valve 58 may be a conventional actuatable valve, or ideally may be a Rapid Valve™ actuatable valve manufactured and marketed by Source Vagabond Systems, Inc., of Israel. In this embodiment, tubing 56 is coupled to the handle bars of the bicycle, so that dispensing valve 58 is readily accessible to the mouth of the user. When the user wishes to drink, he merely actuates valve 58 with his mouth, as by sucking or pinching. This serves to open the valve, and the water, under pressure, flows from the container into the user's mouth.

The other end of conduit 54 extends a short distance into container 42. Additional tubing 60 may be coupled to conduit 54 inside the container extending towards the bottom of the container, as shown. It will be appreciated that the additional tubing may be one of two kinds. In one option, the tubing is slightly larger in diameter than the inside diameter of conduit 16, and tightly engages the inside surface of conduit 16. Alternatively, the tubing may have a slightly smaller diameter than the outer diameter of end 20 of conduit 16. In this case, the tubing is pushed onto conduit 16 for tight engagement with the outer walls of conduit 16.

Operation of the dispensing device of the present invention is as follows. A dispensing device 40 is assembled, preferably in the factory. Thus, a pressure valve 50 is inserted in the pressure valve holder, a relief valve 52 is mounted in the relief valve holder, drinking tubing 56 having a dispensing valve 58 is coupled to the upstanding end of the liquid conduit 54, and additional tubing 60 is coupled to the end of conduit 54 extending into the liquid container. An empty liquid container 42, able to hold liquid under pressure, is partly filled with water or other liquid for dispensing. A selected volume remains only with air, e.g., one quarter or one fifth of the container's volume. Dispensing device 40 is secured to the top of the container, with tubing 60 extending into the liquid. A bicycle pump or gas cylinder or other source of pressurizing gas is coupled to pressure valve 50 and the air in container 42 is pressurized to the desired pressure, e.g., up to about 5 Bar. It will be appreciated that tubing 56, as far as the dispensing valve 58, is also under pressure. Relief valve 52 is adapted and configured to limit the pressure in the container to a pre-selected level, and to prevent leakage of gas beneath that level. Thus, should the pressure inside the container rise above a pre-selected threshold value during pressurization, relief valve 52 will open to regulate the pressure.

Liquid container 42, with the pressurized liquid inside, is mounted in an appropriate holder 44. Tubing 56 is fixed in the desired position close to the mouth of the user. When the user wishes to drink, he or she merely actuates dispensing valve 58 with his or her mouth, and the pressure in the container forces the liquid out of container 42 through tubing 56 and into the user's mouth. If desired, dispensing valve 58 may also be configured for manual actuation, so the user can optionally actuate the valve by hand under suitable conditions.

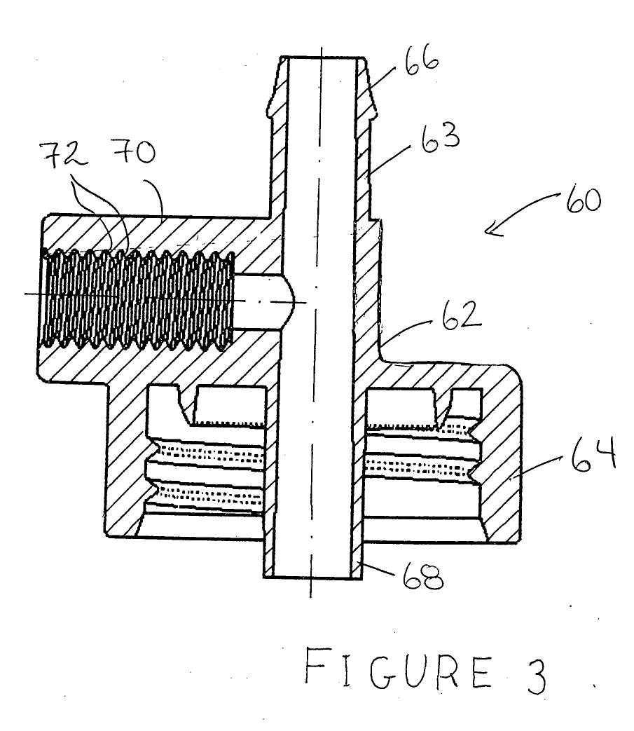

FIG. 3 is a schematic sectional illustration of a dispensing device 60, according to another embodiment of the invention having no relief valve. Dispensing device 60 is formed of a unitary body 62 with an integrally formed cap portion 64 for sealingly connecting the dispensing device to a liquid container (not shown) capable of holding a liquid under pressure. Cap portion 64 is illustrated as having internal screw threads adapted and configured to engage screw threads on the neck of a container.

Body 62 also includes an integrally formed conduit 63 for permitting outflow of liquid from the liquid container. As in FIG. 2, one end of conduit 63 includes an external nipple 66 adapted and configured to sealingly hold tubing (not shown) having a dispensing valve. The other end 68 of conduit 63 may be coupled to extra tubing extending inside the container.

Body 62 further includes an integrally formed holder 70 for a pressure valve for increasing the air pressure in the container. In the embodiment of FIG. 3, holder 70 is sized and shaped like a conventional tire valve tube, and is formed, as by plastic injection, with internal screw threads 72 for holding a standard tire valve, which serves to pressurize the air in the container.

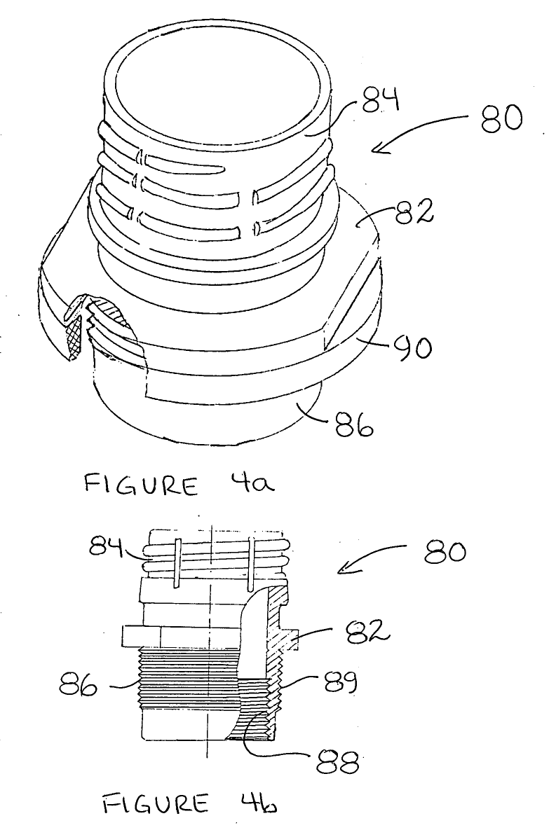

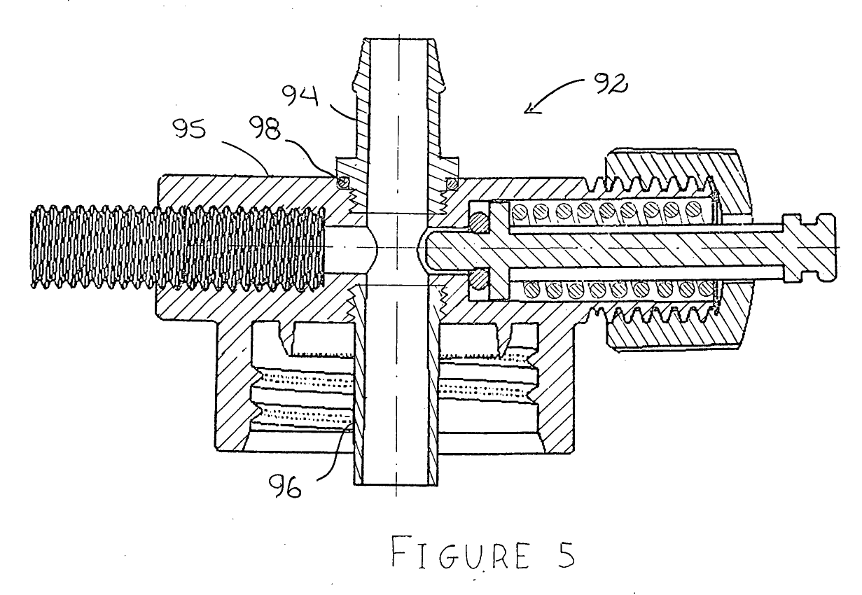

As stated above, the dispensing device of the present invention is suited for use with a variety of different liquid containers. FIGS. 4a and 4b are respective perspective and sectional illustrations of an adapter 80 according to one embodiment of the invention for use in coupling liquid containers having differently shaped necks to the dispensing device of the invention. Adapter 80 includes a base 82 from which protrudes an upstanding neck 84 having external threads adapted and configured to sealingly engage the cap portion of the dispensing device. The lower portion of base 82 defines a cylindrical adapter portion 86, having either or both internal 88 and external 89 screw threads. The external screw threads 89 are designed to engage the screw threads of liquid containers having internal screw threads, such as the aluminum SIGG drinking bottles described above. The internal screw threads 88 are intended to engage the outer screw threads of conventional liquid drink containers having a different diameter than soft drink bottles. A depending skirt 90 may be provided to serve as an additional seal, to ensure against leakage of liquid or gas from the liquid container.

It will be appreciated that, alternatively, a plurality of dispensing devices may be manufactured, each formed with a cap portion designed particularly to engage the neck of a differently shaped liquid container.

FIG. 5 is a schematic sectional illustration of a dispensing device 92 illustrating, by way of example only, one possibility for forming the dispensing device of two or more units which are assembled into a single dispensing device, before use. Dispensing device 92 includes a liquid conduit formed of two separate pieces, an upper conduit 94 and a lower conduit 96, both mounted in a device body 95. Upper conduit 94 is provided with suitable sealing means 98, here illustrated as an O-ring, and both upper and lower conduits are sealingly assembled into a single dispensing device.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A liquid dispensing device for use with a container for holding a liquid under pressure, the dispensing device comprising:
a cap portion for sealingly connecting the dispensing device to the container;
a conduit for permitting outflow of liquid under pressure from the container; and
a holder for a pressure valve providing for increasing the air pressure in the container;
wherein said cap portion, conduit and holder form a single unit.

2. The liquid dispensing device according to claim 1, further comprising a unitary body, wherein said cap portion, said conduit and said holder are integrally formed with said body.

3. The liquid dispensing device according to claim 1, wherein said cap portion is configured and adapted to connect to a conventional drink container having a threaded neck.

4. The liquid dispensing device according to claim 1, wherein said single unit further comprises a pressure valve mounted in said holder.

5. The liquid dispensing device according to claim 4, wherein said pressure valve is a standard tire valve.

6. The liquid dispensing device according to claim 2, further comprising a pressure valve mounted in said integrally formed holder.

7. The liquid dispensing device according to claim 6, wherein said pressure valve is a standard tire valve.

8. The liquid dispensing device according to claim 1, further comprising a relief valve for limiting pressure inside the container during pressurizing.

9. The liquid dispensing device according to claim 2, further comprising a relief valve for limiting pressure inside the container during pressurizing.

10. The liquid dispensing device according to claim 9, wherein said relief valve includes a housing integrally formed with said dispensing device body.

11. The liquid dispensing device according to claim 10, wherein said relief valve further includes a spring biased valve stem sealingly mounted in in said housing.

12. A liquid dispensing device for use with a container for holding a liquid under pressure, the dispensing device comprising:
a unitary body having:
an integrally formed cap portion for sealingly connecting the dispensing device to the container;
an integrally formed conduit for permitting outflow of liquid under pressure from the container; and
an integrally formed holder for a pressure valve, said pressure valve adapted and configured to provide for increasing the air pressure in the container;
a relief valve integrally formed with said body; and
tubing sealingly coupled to a first end of said integrally formed conduit outside of said liquid container, said tubing having a dispensing valve disposed therein for actuation by a user so as to permit a flow of liquid under pressure from said container through said tubing.

13. A method for forming a dispensing device for use with a container for holding a liquid under pressure, the method comprising:
forming a cap portion for sealingly connecting the dispensing device to a container;
forming a conduit for permitting outflow of liquid under pressure from the container;
forming a holder for a pressure valve providing for increasing the air pressure in the container; and
wherein said cap portion, said conduit, and said holder form a single dispensing device unit.

14. The method according to claim 13, further comprising mounting a pressure valve in said holder.

15. The method according to claim 14, wherein said pressure valve is a tire valve.

16. A method for forming a dispensing device for use with a container for holding a liquid under pressure, the method comprising:
forming a dispensing device body;
integrally forming with said body a cap portion for sealingly connecting the dispensing device to a container;
integrally forming with said body a conduit for permitting outflow of liquid under pressure from the container;
integrally forming with said body a holder for a pressure valve providing for increasing the air pressure in the container; and
integrally forming with said body a housing for a relief valve.

17. The method according to claim 16, further comprising sealingly coupling tubing to a first end of said integrally formed conduit outside of said liquid container, said tubing having a dispensing valve mounted therein for actuation by a user so as to permit a flow of liquid under pressure from the container through said tubing.

18. The method of claim 17, further comprising sealingly coupling additional tubing to a second end of said integrally formed conduit inside said liquid container, said additional tubing being adapted and configured to extend into said container.
